(19) United States
(12) Patent Application Publication
(10) Pub. No.: US 2005/0273575 A1
(43) Pub. Date: Dec. 8, 2005

(54) Mechanism to invalidate data translation buffer entries a multiprocessor system

(76) Inventor: Shubhendu S. Mukherjee, Framingham, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/859,876

(22) Filed: Jun. 2, 2004

(51) Int. Cl. G06F 12/08

(52) U.S. Cl. 711/207; 711/146; 711/133

(57) ABSTRACT

According to one embodiment a computer system is disclosed. The computer system includes a first central processing unit (CPU) having a translation buffer (TB) to store virtual to physical address translations, and a snoop filter coupled to the first CPU to mirror the operation of the first TB and implemented to search for entries upon receiving an invalidation request from a second CPU.

### FIELD OF THE INVENTION

The present invention relates to computer systems; more particularly, the present invention relates to computer systems having multiple processors.

### BACKGROUND

Computer systems have long used virtual memory to allow multiple processes to share a single processor. Typically, the operating system (OS) associates an address space with each process. Each address space is divided up into one or more multiple fixed size virtual pages. The OS maps these virtual pages to physical pages and keeps the corresponding translations in a software structure called the Page Table. Because the Page Table can be quite large, processors usually cache these translations in a hardware structure called a Translation Buffer (TB).

More specifically, a TB that caches translations for a data segment of a process is referred to as a Data Translation Buffer (DTB). User-level loads and stores access the DTB to obtain the corresponding physical address before accessing memory. A load or store suffers a DTB miss when it accesses the DTB, but cannot find a corresponding translation. In such a case, either the software or a hardware page table walker brings in the corresponding translation to the DTB. In the process, it may also evict an existing entry from the DTB. The pipeline is restarted and typically the load or store is retried once the translation is brought into the DTB.

Whenever the OS changes a page table entry, it also invalidates the corresponding entry in the DTB. The OS changes a page table entry either when it changes the virtual to physical mapping (possibly due to a page swap to disk) or when it changes the protection level for a page. For a uniprocessor system, this is fairly easy and does not take too much of a processor's bandwidth.

However, a DTB invalidate operation in a shared-memory multiprocessor system can take tens of thousands of cycles. This is because whenever a processor changes a page table entry corresponding to a shared virtual page, corresponding entries in all DTBs in all of the other processors must be invalidated.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a computer system;

FIG. 2 illustrates one embodiment of a CPU; and

FIG. 3 illustrates a flow diagram for one embodiment of mechanism to invalidate data translation buffers.

### DETAILED DESCRIPTION

An invalidation mechanism is described. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention

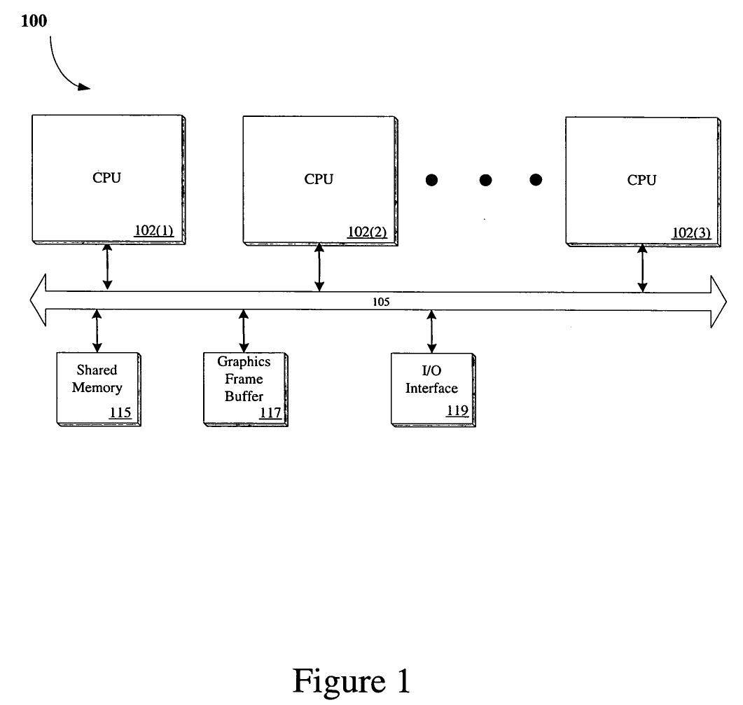

FIG. 1 is a block diagram of one embodiment of a computer system 100. Computer system 100 includes central processing units (CPUs) 102 coupled to bus 105. In one embodiment, CPUs 102 are processors in the Pentium® family of processors including the Pentium® II processor family, Pentium® III processors, and Pentium® IV processors available from Intel Corporation of Santa Clara, Calif. Alternatively, other CPUs may be used.

According to one embodiment, bus 105 includes a high-bandwidth memory bus component and an interrupt controller communications component (ICC). Shared memory 115 is coupled to bus 105.

Memory 115 stores data and sequences of instructions and code represented by data signals that may be executed by the multiple CPUs 102 or any other device included in system 100. In one embodiment, shared memory 115 includes dynamic random access memory (DRAM); however, shared memory 115 may be implemented using other memory types.

In a further embodiment, one or more input/output (I/O) interfaces 119 are coupled to bus 105. An interface 119 provides an interface to devices within computer system 100. For instance, I/O interface 119 may be coupled to a Peripheral Component Interconnect bus adhering to a Specification Revision 2.1 bus developed by the PCI Special Interest Group of Portland, Oreg.

As discussed above, an issue exists for invalidating DTBs in a shared-memory multiprocessor system (e.g., invalidation may take tens of thousands of cycles since corresponding entries in DTBs other processors must be invalidated whenever one processor changes a page table entry corresponding to a shared virtual page).

In current processors, there typically is no hardware mechanism to invalidate DTB entries from the outside of a processor, unlike the manner in which cache blocks in a processor's cache may be invalidated. Consequently, processors invoke a heavyweight inter-processor interrupt on a remote processor having DTB entries that are to be invalidated. The corresponding interrupt handler performs the invalidation.

Such an inter-processor interrupt to invalidate DTB entries is raised on every processor in a shared-memory multiprocessor system since the processor has no knowledge about which processors have cached a copy of a page table entry in their respective DTBs. In some instances, it may be possible to optimize the number of interrupts by keeping the identity of the number of sharers in the page table. However, the processor must at least invalidate all processors caching a copy of the DTB entry to be invalidated.

Past measurements have measured the performance of such DTB invalidations (more commonly known as DTB shootdowns). For example, for a 16-processor Encore Multimax a DTB shootdown time of 1.6 milliseconds has measured, the amount of time tens of millions of instructions may be executed on a single processor.

Thus, a DTB shootdown is a very expensive operation in current multiprocessor systems. As shared-memory multiprocessors become more pervasive, integrated circuit multiprocessors become more common, and larger number of processors are integrated in a single system, the DTB shootdown operation will become a performance limiter for certain large applications and operating systems.

One way to reduce the cost of the DTB shootdown is the implementation of a hardware solution. For instance, when a processor needs to invalidate DTB entries on other processors, the processor issues a DTB invalidation request (very similar to a cache block invalidation request) to other processors. However, such a mechanism does not solve the problem.

First, the DTB is typically searched (or CAM-ed) using virtual addresses. The physical address that comes with the DTB invalidation request is not something that a standard DTB can CAM against. It may be possible to add a second CAM operation on the DTB for the physical address. However, that may increase the latency of a regular DTB access and thereby stretch the pipeline by one or more cycles. Alternatively, the entire DTB can be invalidated, which is not a very appealing solution because valid DTB entries will be unnecessarily invalidated.

Second, to allow external invalidates to snoop the DTB, a second port, or multiplexing of the single read port between DTB read and invalidate requests, would be needed. However, both solutions are undesirable. Adding a second port may increase the size of the DTB, thereby forcing a longer access time (for the CAM). The multiplexing option would slow DTB accesses from the processor.

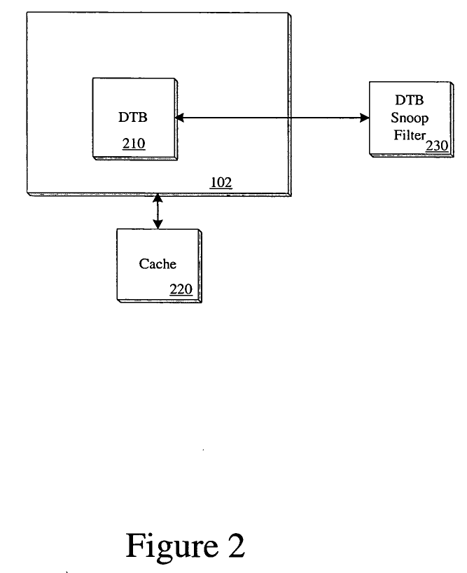

According to one embodiment, a hardware structure is coupled to each CPU 102 in computer system 100. FIG. 2 illustrates one embodiment of a CPU 102 includes a DTB 210. DTB 210 is a hardware structure that caches virtual to physical page translations. In addition, a cache 220 is coupled to CPU 102. Further, DTB snoop filter 230 is coupled to CPU 102.

In one embodiment, DTB snoop filter 230 is a hardware structure that mirrors DTB 210. Accordingly, DTB snoop filter 230 is loaded with an entry each time DTB 210 is loaded on a miss. In a further embodiment, DTB snoop 230 filter acknowledges DTB invalidation requests so that an initiating CPU can make progress.

However in one embodiment, DTB snoop filter 230 includes only physical addresses. Thus unlike DTB 210, DTB scoop filter 230 does not include any other payload. In addition, DTB snoop filter 230 is searched against a physical address that is to be invalidated.

According to one embodiment, if both DTB 210 and DTB snoop filter 230 have a FIFO replacement policy, entries will be evicted correctly from both the structures. However, if DTB 210 and DTB snoop filter 230 have a random replacement policy, there is no direct guarantee that the correct entries are replaced to guarantee that DTB 210 and DTB snoop filter 230 have exactly the same entries. Thus in such an embodiment, a solution is to replace the same exact entry in DTB snoop filter 230 as in DTB 210.

According to one embodiment, every external DTB invalidate operation will be searched at DTB snoop filter 230. A match will indicate that the DTB 210 has a corresponding entry that must be invalidated. Subsequently, CPU 102 will flush all non-committed instructions, find and invalidate the corresponding entries from DTB 210 and DTB snoop filter 230, and restart.

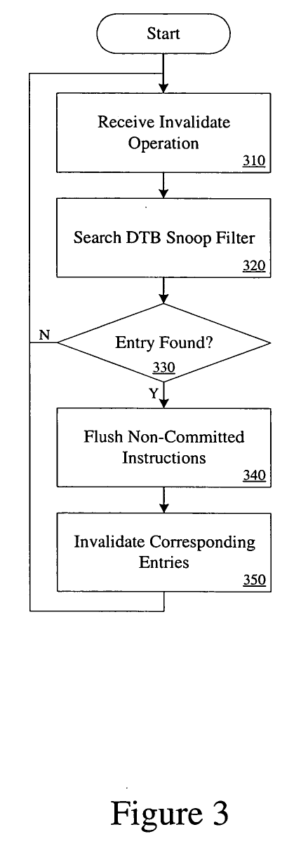

FIG. 3 is a flow diagram illustrating one embodiment of the operation at a CPU 102 and corresponding DTB snoop filter 230 upon receiving an invalidate operation. At processing block 310, an invalidate operation from another CPU (e.g., CPU 102(2)) is received (e.g., CPU 102(1)). As discussed above, the invalidate operation may be the result of a corresponding page table entry being changed at CPU 102(1).

At processing block 320, DTB snoop filter 230 is searched for the entry to be invalidated. In one embodiment, DTB snoop filter 230 is searched via a CAM operation. At processing block 330, it is determined whether the entry is stored within DTB snoop filter 230. If the entry is not located within DTB snoop filter 230, no action is taken and control is returned to processing block 310 where another operation may be received.

If, however, the table entry is found within DTB snoop filter 230, all non-committed instructions are flushed from CPU 102, processing block 340. According to one embodiment, DTB snoop filter 230 has an index into DTB 210. Thus, if the table entry is found in DTB snoop filter 230, there is no need to search DTB 210. Instead, DTB snoop filter simply picks up the entry.

At processing block 350, the corresponding table entry is invalidated at DTB 210 and DTB snoop filter 230. According to one embodiment, DTB snoop filter 230 transmits an interrupt to CPU 102. In response, CPU 102 halts operation while the entry is removed from DTB 210. In another embodiment, DTB snoop filter 230 directly invalidates DTB 210. In such an embodiment, DTB snoop filter 230 uses a standard write port to directly access DTB 210. Thus, there is no need for CPU 102 to stop.

The above-described mechanism features a hardware CAM structure that an incoming DTB invalidation request snoops against. Thus, unnecessary shootdowns are filtered out and only shootdowns that will invalidate a true DTB entry in the processor are scheduled.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

1. A computer system comprising:
a first central processing unit (CPU) having a translation buffer (TB) to store virtual to physical address translations; and
a snoop filter, coupled to the first CPU, to mirror the operation of the first TB and implemented to search for entries upon receiving an invalidation request from a second CPU.

2. The computer system of claim 1 wherein a match found at the snoop filter during a search for entries indicates that an entry is to be invalidated at the snoop filter and the TB.

3. The computer system of claim 2 wherein non-committed instructions at the first CPU are flushed prior to the entry being invalidated at the snoop filter and the TB.

4. The computer system of claim 1 wherein the snoop filter acknowledges invalidation requests received from the second CPU.

5. The computer system of claim 1 wherein the snoop filter is loaded with an entry each time the TB is loaded on a miss.

6. The computer system of claim 5 wherein the snoop filter and the TB implement a first in first out (FIFO) replacement policy to evict entries.

7. The computer system of claim 5 wherein the snoop filter and the TB implement a random replacement policy to evict entries.

8. The computer system of claim 7 wherein the same entries within snoop filter and the TB are replaced.

9. The computer system of claim 1 wherein the snoop filter comprises only physical addresses.

10. A method comprising:
receiving an invalidation request at a first central processing unit (CPU) from a second CPU to invalidate an entry within a translation buffer (TB) at the first CPU;
searching a snoop filter coupled to the first CPU to find the entry; and
invalidating the entry at the TB and the snoop filter if the entry is found within the snoop filter.

11. The method of claim 10 further comprising flushing non-committed instructions at the first CPU prior to the entry being invalidated at the snoop filter and the TB.

12. The method of claim 10 wherein invalidating the entry at the TB comprises:
transmitting an interrupt from the snoop filter to the first CPU; and
halting the operation of the first CPU; and
removing the entry from the TB.

13. The method of claim 10 wherein invalidating the entry at the TB comprises the snoop filter directly accessing the TB to invalidate the entry.

14. The method of claim 13 wherein the snoop filter uses a standard write port to access the TB.

15. A snoop filter comprising a table comprising physical address entries corresponding to entries stored in a translation buffer (TB) implemented to store virtual to physical address translations, the table to mirror the operation of the first TB and implemented to search for entries upon receiving an invalidation request from a second CPU.

16. The snoop filter of claim 15 wherein a match found at the snoop filter during a search for entries indicates that an entry is to be invalidated at the snoop filter and the TB.

17. The snoop filter of claim 15 wherein the snoop filter is loaded with an entry each time the TB is loaded on a miss.

18. The snoop filter of claim 17 wherein the snoop filter and the TB implement a first in first out (FIFO) replacement policy to evict entries.

19. The snoop filter of claim 17 wherein the snoop filter and the TB implement a random replacement policy to evict entries.

20. The snoop filter of claim 19 wherein the same entries within snoop filter and the TB are replaced.

21. A computer system comprising:
a first central processing unit (CPU);
a second CPU having a translation buffer (TB) to store virtual to physical address translations;
a main memory device coupled to the first CPU and the second CPU; and
a snoop filter, coupled to the second CPU, to mirror the operation of the first TB and implemented to search for entries upon receiving an invalidation request from the first CPU.

22. The computer system of claim 21 wherein a match found at the snoop filter during a search for entries indicates that an entry is to be invalidated at the snoop filter and the TB.

23. The computer system of claim 22 wherein non-committed instructions at the first CPU are flushed prior to the entry being invalidated at the snoop filter and the TB.

24. The computer system of claim 21 wherein the snoop filter acknowledges invalidation requests received from the first CPU.

25. The computer system of claim 21 wherein the snoop filter comprises only physical addresses.
